(19) United States
(12) Patent Application Publication
(10) Pub. No.: US 2015/0177765 A1
(43) Pub. Date: Jun. 25, 2015

(54) Electronic Device and Method of Notifying Information

(71) Applicants: Kabushiki Kaisha Toshiba, Tokyo (JP); Toshiba Lifestyle Products & Services Corporation, Tokyo (JP)

(72) Inventor: Atsushi Nakajima, Higashimurayama (JP)

(21) Appl. No.: 14/466,797

(22) Filed: Aug. 22, 2014

(30) Foreign Application Priority Data
Dec. 20, 2013 (JP) 2013-263797

(51) Int. Cl. G05F 1/66; G05B 15/02

(52) U.S. Cl. CPC G05F 1/66; G05B 15/02

(57) ABSTRACT

According to one embodiment, an electronic device includes, a selection module, a holding module, and presentation module. The selection module configured to select background processing which is not explicitly shown to a user by the apparatus itself from among a plurality of types processing executed by the electronic device. The holding module configured to hold particulars of the background processing selected by the selection module, and a start time and an end time of the background processing. The presentation module configured to present the particulars, the start time, and the end time of the background processing held in the holding module or to transmit them to an external device upon request.

### CROSS-REFERENCE TO RELATED APPLICATIONS

This application is based upon and claims the benefit of priority from Japanese Patent Application No. 2013-263797, filed Dec. 20, 2013, the entire contents of which are incorporated herein by reference.

### FIELD

Embodiments described herein relate generally to an electronic device and a method of notifying information.

### BACKGROUND

As an interface standard between a household electrical appliance related to living (hereinafter referred to as a home appliance) such as a refrigerator, a washing machine, and a light fitting and an electronic device capable of displaying an image, such as a television receiver or a monitor device connected to a recorder, ECHONET [Energy Conservation and Homecare Network] Lite protocol, as established by the ECHONET Consortium, has come into service, and devices compatible with EchonetLite are available.

An electronic device which supports EchonetLite can notify information such as power consumption and a status of the electronic device itself to another device which supports EchonetLite. With this mechanism, power consumption of the electronic device can be monitored from another terminal device at arbitrary timing. Power consumption of the electronic device can also be monitored using standards other than EchonetLite.

In these circumstances, when power consumption, etc., of a television receiver, for example, is monitored by a portable terminal device, a temporary increase in the power consumption is sometimes detected despite a time period in which the television receiver is not operated. Similarly, with respect to home appliances, there are cases where a temporary increase in the power consumption is detected at timing not expected by a user when, for example, a defrosting operation of a refrigerator is started.

When power consumption of an electronic device is to be monitored, if some kind of background processing is executed in the electronic device, the power consumption that is greater than the user had expected may be detected due to unawareness of this background processing.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 shows an exemplary diagram showing an example of signal transfer between an image display device (electronic device) and a peripheral device (portable terminal device) according to an embodiment;

FIG. 2 shows an exemplary diagram showing an example of event data stored in the image display device according to an embodiment;

FIG. 3A shows an exemplary diagram showing an example of information transfer between the image display device and the portable terminal device like software operation according to an embodiment;

FIG. 3B shows an exemplary diagram showing an example of a method of notifying (indicating) information of the image display device like software operation according to an embodiment;

FIG. 4 shows an exemplary diagram showing an example of the image display device (a television receiver) according to an embodiment; and

FIG. 5 shows an exemplary diagram showing an example of a portable terminal device (a tablet device) according to an embodiment.

### DETAILED DESCRIPTION

Various embodiments will be described hereinafter with reference to the accompanying drawings.

In general, according to one embodiment, an electronic device comprising: a selection module module, a holding module, and an presentation module. The selection module configured to select background processing which is not explicitly shown to a user by the apparatus itself from among a plurality of types processing executed by the electronic device. The holding module configured to hold particulars of the background processing selected by the selection module, and a start time and an end time of the background processing. The presentation module configured to present the particulars, the start time, and the end time of the background processing held in the holding module or to transmit them to an external device upon request.

Embodiments will now be described hereinafter in detail with reference to the accompanying drawings.

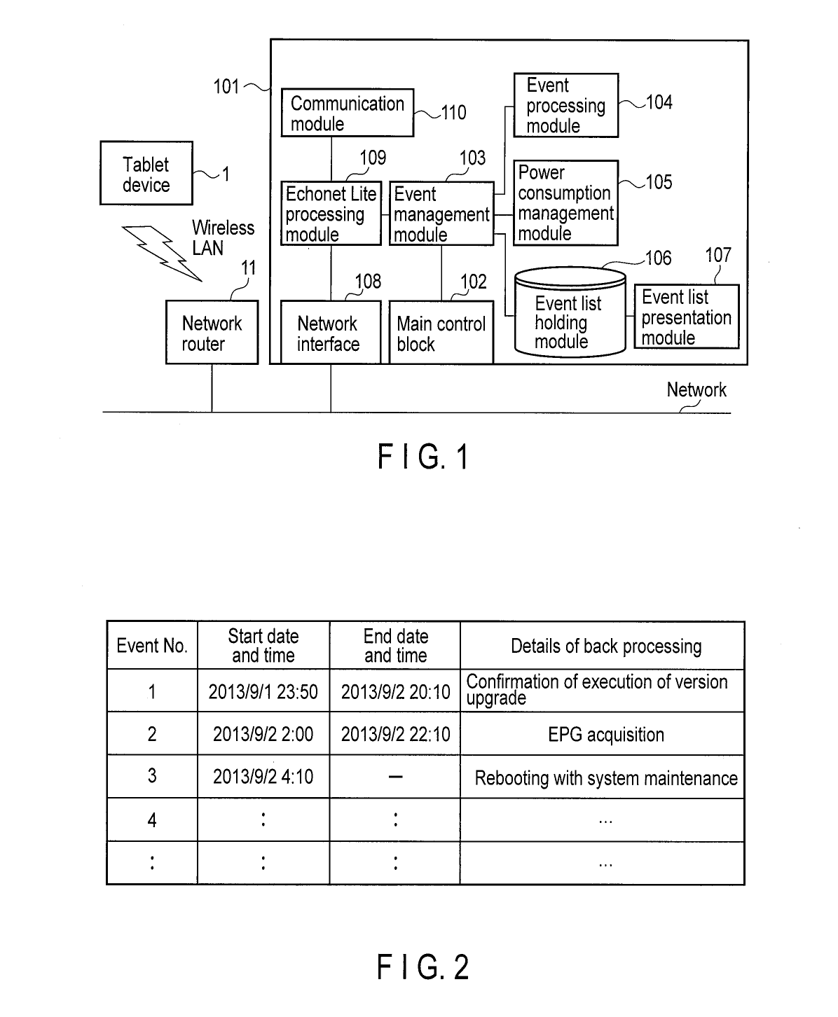

FIG. 1 shows an example of an image display device (electronic device) according to one of the embodiments and a peripheral device capable of transferring information via a network. It should be noted that the elements and structures described below may be those which can be realized by software operated by a microcomputer (a processor or a central processing unit [CPU]), or those which can be realized by hardware.

An image display device (electronic device) 101 shown in FIG. 1 is a broadcast receiving apparatus (a television receiving apparatus) which reproduces, for example, a broadcast signal or video content that is input externally.

The image display device 101 includes, a main control block 102, an event management module 103, an event processing module 104, a power consumption management module 105, an event list holding module 106, an event list presentation module 107, a network interface 108, an EchonetLite processing module 109, a short-range wireless communication module 110, etc.

The image display device 101 connects to a network router 11 located on a network through the network interface 108.

The network router 11 is able to transfer information between the image display device 101 and a portable terminal device 1, which is a tablet device, for example. In the presence of the network router 11, information conforming to the EchonetLite standard can be transferred between the image display device 101 and the tablet device (portable terminal device) 1.

In the image display device 101 shown in FIG. 1, the EchonetLite processing module 109 accepts the current power consumption value (power consumption data) from the event management module 103, acquired by the power consumption management module 105, in accordance with an instruction of acquiring a power consumption value, for example, from the tablet device 1, via the network interface 108. Then, the EchonetLite processing module 109 sends the current power consumption value (power consumption data) to the tablet device 1 via the network interface 108. The power consumption management module 105 acquires an inquiry from the event management module 103, and sends back the current power consumption value (power consumption data).

Note that, in description, while the image display device (television broadcast receiving apparatus) 101 as being the end from which power consumption is acquired, and the tablet device 1 as being the end that acquires the power consumption, the functions of the image display device 101 and the tablet device 1 may be switched or they may be structured to mutually acquire power consumption from each other.

The event processing module 104 executes a back processing executed at background in accordance with an instruction from the main system (main control block) 102 or a change of a set value by a user. Note that, the back processing is, for example, the processing of acquiring (updating) electronic program guide (EPG) information or updating installed firmware (program) in a main power supply off-state in which an image is not displayed or recorded by the image display device (television receiving apparatus) 101 (that is, the state in which the power is turned off by a remote-control terminal). The back processing is being performed in the main power supply-on state may also be defined as back processing, does not display an image indicating that the above-mentioned processing. For example, with respect to the back processing such as the EPG acquisition processing and the firmware update processing, when an ordinary program image is displayed, an indication that these kinds of back processing are now at work is not displayed on screen. That is, the back processing is the processing which does not explicitly display from the device in question that it is working to a user. Further, there are cases where two or more types of the back processing are executed simultaneously. The event processing module 104 notifies the time when the back processing was started and the time when it was ended to the event management module 103.

The back processing includes the case where only the back processing is executed (i.e., the above case) and the case where it is executed simultaneously with front processing such as display (reproduction) of a received image. Here, regardless of whether the back processing is executed or not, front processing is not recorded as an event. (It is appropriate to consider that a user does not raise questions about the execution of the front processing.)

That is, when the back processing is executed, a factor (operation) which becomes a cause for question by a user such as an increase in power consumption is produced. In such a situation, in the case where information by way of EchonetLite is acquired at the time of executing the processing executed even at the time when the user has assumed that power is turned off, for example, when acquiring the EPG information, performing data collection for a version upgrade, and rebooting the device for maintenance, the time and the specifics of the processing (back processing) are recorded as an event for the user's reference (The recorded event of the back processing is capable of check (viewing) by the user (he/she)). This helps the user (he/she) to resolve the question if user (he/she) had a question about the increase in, for example, the power consumption by referring to the event. Note that when two or more types of the back processing are executed simultaneously, they should both be recorded as events.

Mentioned above, of several types of processing executed by the image display device 101, the front processing is not recorded as an event and the event of the back processing is recorded in association with the event particulars, time, and power consumption. In this way, recording of information regarding the front processing that the user is already aware of, namely, information that is not particularly necessary for the user can be omitted.

The event list holding module 106 stores as a list the particulars of the back processing performed when acquisition of the power consumption value was requested from another device (tablet device 1).

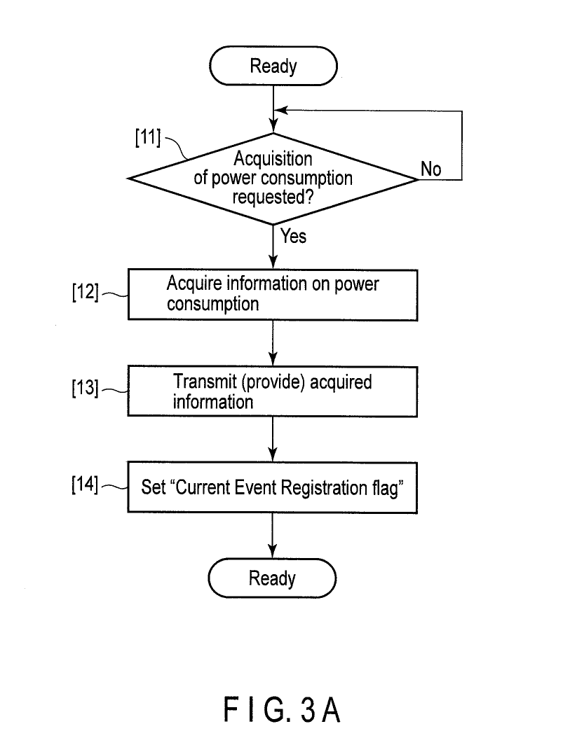

The event list presentation module 107 presents information recorded in the event list holding module 106 to the user. FIG. 2 shows an example of a list held by the event list presentation module 107. In FIG. 2, the column of end date and time present “-” of the event list presentation module 107 meaning “currently being continued”.

More specifically, the event management module 103 records the start date and time and the back processing particulars in a memory, based on a notification of a start of an event from the event processing module 104.

Also, in response to an inquiry from the EchonetLite processing module 109, the event management module 103 acquires, for example, the power consumption value from the power consumption management module 105, and passes it on to the EchonetLite processing module 109. Simultaneously with that, the event management module 103 confirms whether there is ongoing a back processing in the memory, and when there is such a back processing (an event), the event management module 103 records it in the event list holding module 106. When recording of the event in the event list holding module 106, the end date and time value as “-”. Then, a flag (a current event registration flag) representing that the recordation is made to the event list holding module 106 is set.

The event management module 103 confirms the presence of the current event registration flag when there was a notification of event termination from the event processing module 104. When the flag is set, of the event recorded in the event list holding module 106, the corresponding event is searched for based on the start date and time and the back processing particulars, and the part of the end date and time is updated from “-” to the actual end date and time. If no current event registration flag is set, information regarding the event of that back processing is discarded.

The back processing includes processing which is essential for a system and processing in which the on/off state can be switched by the setting. That is, for the back processing that is not essential, at the time of displaying the back processing particulars (at the time of checking (or viewing) by the user), for example, an item which sets the back processing (setting) is presented. In this way, the back processing can be aborted at discretion by the user. In this case, power consumption can be reduced. As the back processing which is not essential, data collection for automatically performing a version upgrade, acquisition of the EPG information exceeding the specified number of times, and reading of reservation e-mails (confirmation of whether e-mails have arrived) exceeding the prescribed number of times for recording reservation through a network, for example, are noted.

The event management module 103 records the date and time and the back processing particulars as an event, when information such as a power consumption value is acquired via EchonetLite during execution of the back processing.

The user is able to confirm it later, since the event is held in the event list holding module 106. The event may be confirmed in the device from which information was acquired, or may be recorded in a predetermined area (recording server) on the network, for example, so that it can be acquired from another device. The event can be presented (to send) to a requesting device, also.

If acquisition of information via EchonetLite is not conducted during execution of back processing, the back processing at that time is not recorded as an event.

As described above, if user (he/she) questions the increase in power consumption when user (he/she) confirmed it via EchonetLite, for example, the reason can be presented with the event list presentation module 107 by an operation of confirming the event, and then checking (or viewing) by the user (he/she).

Further, as the information (event) which can be transferred between the image display device 101 and the tablet device 1, apart from acquiring the power consumption information, examples of the events are acquiring the device name of the image display device 101 and turning on power (activating) or turning off power (deactivating).

In addition, FIG. 1 shows an example in which the image display device 101 itself shows the event list. However, the image display device 101 may only provide the event list to a different device which requested, for example, acquisition of the power consumption value (i.e., which acquired the power consumption value), via the network, etc. Further, the different device may be a device which can access the event list stored in another device such as a server.

FIG. 2 shows an example of a list of events including processing (back processing) having an acquisition request for a power consumption value, and in which the power consumption value is acquired.

In FIG. 2, the first and the second entries (rows of Event Nos. 1 and 2) present the events which have already been terminated, and the third entry (row of Event No. 3) presents the ongoing event.

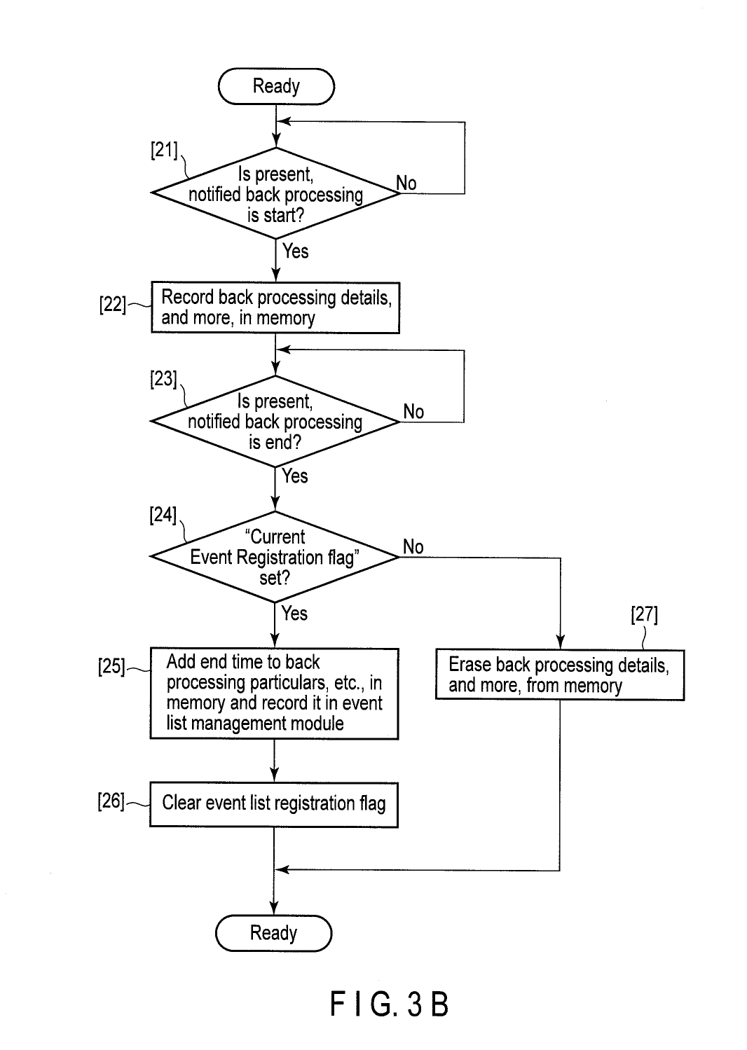

FIGS. 3A and 3B show an operation of the event management module like software operation. Note that the processing of FIGS. 3A and 3B are both executed at arbitrary timing.

FIG. 3A shows acceptance of an inquiry via the EchonetLite processing module mainly and a response thereto.

When an acquisition request (event) for information conforming to the EchonetLite standard is received, for example, from the tablet device 1 [11—YES], the event management module 103 acquires the information which has been requested such as information on power consumption[12], and transmits the acquired information (to the tablet device 1) [13]. Instead of transmitting the acquired information to the tablet device 1, the information may be provided at a predetermined recording area so as to allow an external device such as the tablet device to acquire (read) the information. Further, the information may be provided to a service server, for example, to allow the information to be acquired (or read) by the external device.

Further, the event management module 103 is set a “current event registration flag” indicating that the information was acquired (registered) based on the event (acquisition request for information) [14]. Then, the processing of FIG. 3A returns to the block [11] and executes the loop.

FIG. 3B shows an example of processing that is mainly performed between the tablet device and the event processing module.

If a notification of start of “back processing” is received from the event processing module 104 [21—YES], the event management module 103 stores the particulars of the “back processing” in a memory [22].

Then, the processing waits for termination of the “back processing”, and if a notification of the termination of “back processing” is received [23—YES], existence of a “current event registration flag” is checked (confirmed) [24].

If there is a “current event registration flag” (that is, if a flag is set) [24—YES], the end time is added to the particulars, etc., of the “back processing” in the memory, and recorded in the event list management module [25]. Further, “the current event registration flag” in the event list is cleared (that is, the flag is reset) [26].

If there is no current event registration flag (that is, the flag is not set) [NO in 24], the particulars, etc., of the back processing held by the memory (i.e., in the memory) is erased (discarded) [27].

The processing of FIG. 3B returns to [21] at the beginning, after the blocks [26] and [27], and executes the loop.

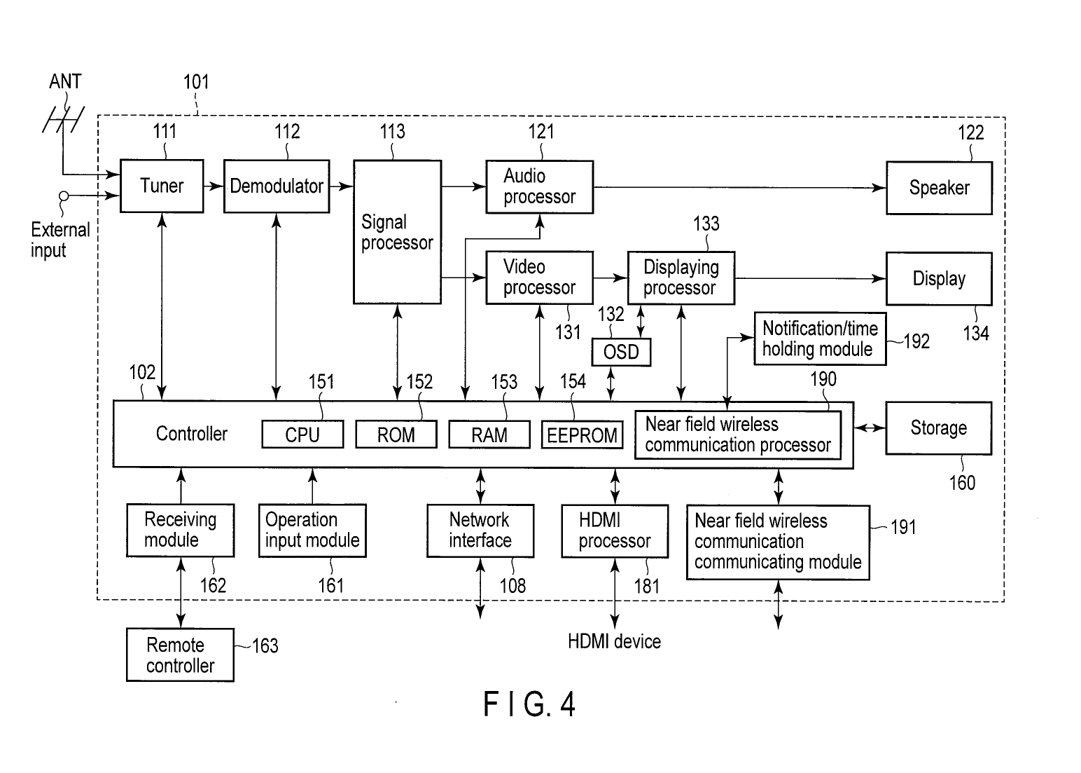

FIG. 4 shows an example of elements of the television apparatus (image display device) 101 which can be utilized for the display device shown in FIG. 1.

The image display device 101 comprises a controller (main control block) 102, an input module 111, a demodulator 112, a signal processor 113, an audio processor 121, a video processor 131, an OSD processor 132, a displaying processor 133, a storage 160, an operation input module 161, a receiving module 162, a network controller 171, a near field wireless communication processor 190, etc. The image display device 101 further comprises a speaker 122 and a display 134. The near field communication communicating module 191 and the notification/time holding module 192 are connected to the near field communication processing module 190. The near field wireless communication processor 190 and the near field wireless communication module 191 are functioning the event management module 103, the event processing module 104, the event list holding module 106, the event list presentation module 107, the EchonetLite processing module 109 and communication near field wireless communication communicating module 110 shown in FIG. 1. The near field wireless communication processor 190 is a communication unit/communication controller conforming to, for example, the Wi-Fi direct or Bluetooth (registered trademark) standard.

The image display device 101 receives a control input (an operation instruction) from a remote controller 163, for example, and supplies a control command corresponding to the operation instruction (control input) to the controller 102. For example, when a power button is pressed, the device is switched from a standby (waiting/main power-off) state to an operating state, and when the power button is pressed again, the device is switched from the operating state to the standby state.

The input module 111 is able to receive a digital broadcast signal, e.g., a terrestrial broadcast signal, a broadcasting satellite (BS) signal, and/or a communication satellite (CS) broadcast signal which can be received through antenna ANT, for example. The input module 111 can also receive content (external input) supplied as a direct input or via a set-top box (STB), for example, which is an external tuner adapted to a pay broadcast, etc., or a channel selector capable of selecting a station which distributes a broadcast of a cable distribution station.

The input module 111 performs tuning (channel selection) of the digital broadcast signal which has been received. The input module 111 supplies the tuned digital broadcast signal to the demodulator 112. Note that the image display device 101 may comprise a plurality of input modules (tuners) 111. In this case, the image display device 101 is able to simultaneously receive a plurality of digital broadcast signals/content items. The input module 111 supplies the external input transmitted via the STB, etc., to the demodulator 112 as it is.

The demodulator 112 demodulates the selected digital broadcast signal/content. In other words, the demodulator 112 acquires moving image data (hereinafter called a stream) such as a transport stream (TS) from the digital broadcast signal/content. The demodulator 112 inputs the acquired stream in the signal processor 113. The television apparatus 101 may comprise a plurality of demodulators 112. The plurality of demodulators 112 can demodulate the plurality of digital broadcast signals/contents, respectively.

The signal processor 113 separates the stream demodulated by the demodulator 112 into a speech component and an image component, and character information and data component for EPG, for example. That is, the signal processor 113 separates the stream into a digital image signal, a digital speech signal, and other data signals such as text data formed of characters and codes referred to as data broadcasting besides the aforementioned component for EPG. The signal processor 113 can separate a plurality of streams demodulated by the plurality of demodulators 112.

The signal processor 113 also supplies the separated digital speech signal to the audio processor 121. The signal processor 113 further supplies the separated digital image signal to the video processor 131. Also, the signal processor 113 supplies a data signal such as EPG data (data for EPG) to the controller 102.

The signal processor 113 is able to convert the above-mentioned stream into data in a recordable state (recording stream) based on the control of the controller 102. Further, the signal processor 113 is able to supply the recording stream to the storage 160 or other modules based on the control of the controller 102.

Furthermore, the signal processor 113 is able to convert (transcode) a bit rate of the stream from that set as original (of the broadcast signal/content) to a different bit rate. That is, the signal processor 113 is able to transcode (convert) the original bit rate of the acquired broadcast signal/content to a lower bit rate as compared to the original bit rate. In this way, the signal processor 113 is able to record the content (program) in a state of a small volume.

The audio processor 121 converts a digital speech signal received from the signal processor 113 into a signal (an audio signal) of a format reproducible by the speaker 122. That is, the audio processor 121 includes a digital-to-analog (D/A) converter, and converts the digital speech signal into an analog audio/speech signal. The audio processor 121 supplies the converted audio/speech signal to the speaker 122. The speaker 122 reproduces speech and audio from the supplied audio/speech signal.

The video processor 131 converts the digital image signal provided from the signal processor 113 into an image signal of a format reproducible by the display 134. In other words, the video processor 131 decodes the digital image signal received from the signal processor 113 into an image signal of a format reproducible by the display 134. The video processor outputs the decoded image signal to the displaying processor 133.

The OSD processor 132 generates an on-screen display (OSD) signal for superimposing, for example, a graphical user interface (GUI) display, caption display, time display, and notification information such as information on arrival of SNS to the tablet device 1 (which can alternatively set to be non-displayed), or information on arrival of speech communication or communication data corresponding to that for the image and audio being reproduced, on a display signal from the video processor to display a superimposed image, based on a data signal supplied from the signal processor 113 and/or a control signal (control command) supplied from the controller 102.

The displaying processor 133 performs image quality adjustment processing of adjusting color, brightness, sharpness, contrast, and the like for the received image signal based on the control from the controller 102, for example. The displaying processor 133 supplies the image signal subjected to image quality adjustment to the display 134. Therefore, the display 134 displays an image based on the supplied image signal.

The displaying processor 133 also superimposes the OSD signal from the OSD processor 132 on the aforementioned display signal from the video processor for which the image quality adjustment processing has been performed, and supplies the superimposed signal to the display 134.

The display 134 includes a liquid crystal display, etc., comprising a liquid crystal display panel comprising a plurality of pixels arranged as a matrix, for example, and a backlight which illuminates the liquid crystal display panel. The display 134 displays an image based on the image signal supplied from the displaying processor 133.

The television apparatus 101 may be configured to comprise an output terminal which outputs the image signal, instead of the display 134. In addition, the television apparatus 101 may be configured to comprise an output terminal which outputs the audio signal, instead of the speaker 122. The television apparatus 101 may be configured to comprise an output terminal which outputs the digital image signal and the digital speech signal.

The controller 102 controls the operation of each of the modules of the image display device 101. The controller 102 comprises a central processing unit (CPU) 151, a read-only memory (ROM) 152, a random access memory (RAM) 153, an EEPROM (nonvolatile memory) 154, etc. The controller 102 also performs various kinds of processing based on an operation signal supplied from the operation input module 161. The controller 102 can also obtain (calculate) an elapsed time based on time information (the clock function or time) at the time of receiving a predetermined notification from a home appliance compatible with EchonetLite and time information at the time when the notification could be displayed. Calculation of the elapsed time may be performed by firmware of the CPU 151 described below.

The CPU 151 comprises a computing element configured to execute various types of computation, etc. The CPU 151 implements various functions by executing the programs held by the ROM 152, the EEPROM 154 or the like. The CPU 151 is often charged with the above-described computation of the elapsing time.

The ROM 152 stores a program for controlling the image display device 101, a program for realizing various functions, and the like. The CPU 151 launches a program stored in the ROM 152 based on the operation signal supplied from the operation input module 161. In this way, the controller 102 controls the operation of each of the modules.

The RAM 153 functions as a work memory of the CPU 151. That is, the RAM 153 stores an arithmetic result of the CPU 151, data read by the CPU 151, and the like.

The EEPROM 154 is a nonvolatile memory which stores various kinds of setting information, programs, etc. The EEPROM 154 holds information of a client device authenticated by the near field wireless communication processor 190 according to need (in accordance with the control of the controller 102).

The storage 160 comprises a storage medium storing content. The storage 160 is, for example, a hard disk drive (HDD), a solid-state drive (SSD), or a semiconductor memory. The storage 160 can store the recording stream or text data supplied from the signal processor 113.

The operation input module 161 includes an operation key which generates an operation signal in accordance with an operation input by the user, for example. Further, the operation input module 161 may be structured such that it receives the operation signal from a keyboard, a mouse, or other input devices capable of generating operation signals. The operation input module 161 supplies the operation signal to the controller 102.

The display 134 of the image display device 101 may be configured to comprise a touch panel function which enables some of functions of the operation input module 161 to be implemented.

The receiving module 162 comprises a sensor or the like which receives an operation signal from the remote controller 163 supplied by an infrared ray (Ir) method, for example. The receiving module 162 supplies the received signal to the controller 102. The controller 102 receives the signal supplied from the receiving module 162, and decodes the original operation signal transmitted from the remote controller 163 by amplifying the received signal and then performing analog-to-digital (A/D) conversion with respect to the amplified signal.

The remote controller 163 generates an operation signal based on the user's operation input. The remote controller 163 transmits the generated operation signal to the receiving module 162 by way of infrared communication. It should be noted that the receiving module 162 and the remote controller 163 may be structured such that they transmit and receive the operation signal by other types of wireless communication using radio waves (RF), etc.

The network controller 171 is connected to a network (the Internet) 1, for example, and can communicate with other devices on the network. The television apparatus 101 can thereby receive/send information from/to an arbitrary device connectable via the network 1, a content supplier, or various data servers which can be connected via the network. In this way, the image display device 101 is able to acquire the content (stream) stored in the content supply source, data server, or arbitrary device including a device at home, which is connected via the network controller 171, and reproduce that content (stream). When VOD content or the like is downloaded from the content supplier connected through the controller 171, for example, since the resource load is heavy, display capability of the image display device 101 may be restricted (and a notification from the home appliance cannot be displayed).

An HDMI processor 181 performs transfer of the control signal and the video and speech (audio) data in accordance with the High-definition Multimedia Interface (HDMI) (registered trademark) standard. The HDMI processor 181 is capable of transmitting content (a stream) including image and speech to an external device or a large-capacity memory (an external HDD), etc., comprising an HDMI terminal and receiving the content (stream) therefrom. The external device is, for example, a Blu-ray (registered trademark) recorder, a digital versatile disk (DVD) recorder, a hard disk (HDD) recorder, an HDMI linkage device connectable with the other device under HDMI standard, and/or a network attached storage (NAS). Further, the image display device 101 can comprise another interface such as a LAN terminal connectable to a serial-ATA (serial-advanced technology attachment) or an HDMI-HEC (HDMI Ethernet Channel), for example.

The near field wireless communication processor 190 (near field wireless communication communicating module 110 in FIG. 1) handles data transfer between a device communicable via the near field wireless communication module 191 conforming to the Bluetooth (registered trademark) standard, for example, and mutual authentication processing or the like with a cooperating device. Information acquired from the authenticated counterpart device, the start and the end time are stored in, for example, the notification/time holding module 192 or the EEPROM 154. While FIG. 4 shows an example in which the short-range wireless communication module 191 and the near field wireless communication processor 190 are provided independently of the network controller 171, they may be formed integrally with the network controller 171 (or a part thereof may be shared). Further, when the network controller 171 is formed integrally with the short-range wireless communication module 191 and the near field wireless communication processor 190, the notification/time holding module 192 is connected to the network controller 171.

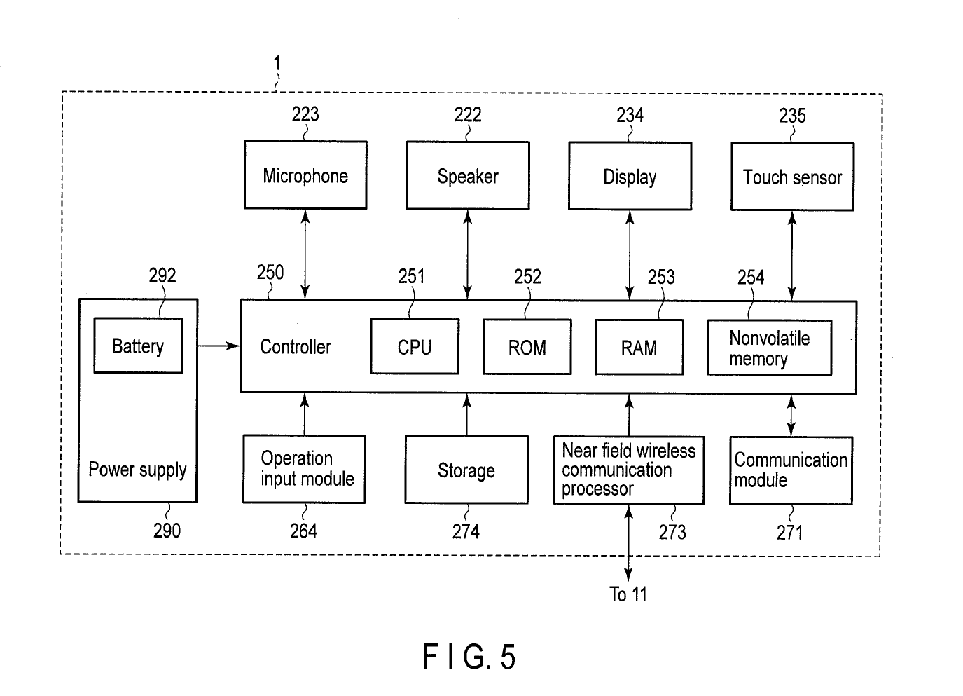

FIG. 5 shows an example of elements of a portable terminal device which can be applied to the tablet device 1 shown in FIG. 1.

The tablet device 1 comprises a controller 250, an operation input module 264, a communication module 271, a near field wireless communication processor 273, and a storage 274. The near field wireless communication processor 273 is a communication unit/communication controller conforming to, for example, the Wi-Fi direct or Bluetooth standard.

Also, the tablet device 1 comprises a speaker 222, a microphone 223, a display 234, and a touch sensor 235 (integrated with the display 234).

The controller 250 controls the operation of each of the modules of the tablet device 1. The controller 250 includes a CPU 251, a ROM 252, a RAM 253, a nonvolatile memory 254, etc.

The controller 250 performs various kinds of processing based on an operation signal supplied from the operation input module 264 or the touch sensor 235. The controller 250 also causes the display 234 to display a notification given from a home appliance through the near field wireless communication processor 273. Note that when the tablet device 1 is connected to the network and the content is being downloaded, the aforementioned notification acquired through the near field wireless communication processor 273 is not displayed. (That is, when a resource load during the download, etc., is heavy, the aforementioned notification is given after completion of the download.)

The CPU 251 executes various types of computation processing. The CPU 251 implements various functions by executing programs held by the ROM 252 or the nonvolatile memory 254.

The ROM 252 stores a program for controlling the image display device 101, a program for realizing various functions, and the like. The CPU 251 launches a program stored in the ROM 252 based on the operation signal from the operation input module 264. In this way, the controller 250 controls the operation of each of the modules.

The RAM 253 functions as a work memory of the CPU 251. That is, the RAM 253 stores data such as an arithmetic result of the CPU 251, data read through the CPU 251, and data necessary for authenticating a home appliance connected via the near field wireless communication processor 273.

The nonvolatile memory 254 stores various kinds of setting information, programs, a result of authentication of the home appliance connected via the near field wireless communication processor 273, and the like.

Also, the controller 250 outputs an image signal for display in accordance with an application executed by the CPU 251, and displays the image signal on the display 234. Therefore, the display 234 reproduces a moving image (graphic), a still image, character information, or the like, based on the moving image signal (video) supplied. The controller 250 can also generate a speech signal for reproduction of various sounds, etc., in accordance with the application executed by the CPU 251, and have it output from the speaker 222. Therefore, the speaker 222 reproduces a sound (audio/speech) based on the audio signal (audio) supplied.

The microphone 223 collects the sound around the tablet device 1, and generates an audio signal. The audio signal is converted into audio data by the controller 250 after A/D conversion is performed, and the converted audio data is temporarily held in the RAM 253. The audio data is converted into speech/audio sound (reproduced) by the speaker 222 after D/A conversion is performed as needed. The audio data is also used as a control command by speech recognition processing after A/D conversion is performed.

The display 234 comprises a liquid crystal display device and the like comprising a liquid crystal display panel comprising a plurality of pixels arranged as a matrix, for example, and a backlight which illuminates the liquid crystal display panel.

The touch sensor 235 generates an operation signal based on an operation on a screen displayed on the display 234 (a user input corresponding to screen display), and supplies it to the controller 250.

The operation input module 264 comprises a key for generating the operation signal in accordance with the user's operation input, for example. The operation input module 264 comprises, for example, a volume adjustment key for adjusting the volume, a brightness adjustment key for adjusting display brightness of the display 234, and a power key for switching (on/off) the state of power of the tablet device 1. The operation input module 264 may be configured such that it receives an operation signal from a keyboard, a mouse, or other input devices capable of generating operation signals. For example, if the tablet device 1 comprises a USB terminal or a module conforming to the Bluetooth standard, the operation input module 264 receives an operation signal from the USB or the input device connected by way of Bluetooth, and supplies it to the controller 250.

The communication module 271 can communicate with another device on a network via a LAN or a wireless LAN. Thus, the tablet device 1 can acquire and reproduce content (a stream) held in a content supply source, a data server, or an arbitrary device including the one at home which is connected via the network.

The near field wireless communication processor 273 handles data transfer to and from the home appliance, and data processing. That is, the tablet device 1 can display on the display 234 a notification received from the home appliance (EchonetLite compatible device) by carrying out communication with the home appliance connected via the near field wireless communication processor 273.

The storage 274 includes a hard disk drive (HDD), a solid state drive (SSD), a semiconductor memory, or the like. The storage 274 can store a program and an application executed by the CPU 251 of the controller 250, content including a moving image, and various kinds of data or the like.

A power supply 290 comprises a battery (rechargeable battery) 292, and a terminal (for example, a DC jack) for connecting with an adapter for receiving power from a commercial power supply. The power supply 290 charges the battery 292 by power received from the commercial power supply. Also, the power supply 290 supplies the power charged in the battery 292 to each module of the tablet device 1.

As can be seen, in the image display device to which the embodiment is applied, when a user, for example, confirms power consumption by way of EchonetLite and questions the increase in the power consumption, an operation of event confirmation can be carried out and the reason can be identified from the event list indication module.

Further, when information acquisition by way of EchonetLite is not carried out during execution of back processing, the back processing is not recorded as an event (and discarded if it has been recorded). Therefore, the user will not have undue questions or doubts.

In the above embodiment, the processing in which the image display device (television receiving apparatus) 101 executes the back processing and records that back processing has mainly been described. However, such processing may be executed by an air conditioner or a refrigerator. That is, the air conditioner may execute back processing such as elimination for dew condensation (defrosting) processing, and record the back processing and power consumption. Alternatively, the refrigerator may execute back processing of defrosting and the like, and record the particulars of processing and power consumption. Processing to be carried out later is the same as the processing of the image display device (television receiving apparatus) 101 in the above embodiment.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a selection module configured to select background processing which is not explicitly shown to a user by the apparatus itself from among a plurality of types processing executed by the electronic device;
a holding module configured to hold particulars of the background processing selected by the selection module, and a start time and an end time of the background processing; and
an presentation module configured to present the particulars, the start time, and the end time of the background processing held in the holding module or to transmit them to an external device upon request.

2. The electronic device of claim 1, wherein the selection module does not select processing which is explicitly shown to the user by the electronic device itself from among the plurality of types processing.

3. The electronic device of claim 1, wherein the background processing is executed at background of the processing explicitly shown to the user, or executed at background in a state where a main power supply of the electronic device is turned off.

4. The electronic device of claim 1, wherein the background processing is at least any one of EPG acquisition, firmware update, defrosting, and condensation elimination.

5. The electronic device of claim 1, further comprising:
a management module which sets the particulars of the background processing, the start time, and the end time held in the holding module to be non-stored if a request is not made by a requestor.

6. A method of notifying information comprising:
holding particulars of background processing and a start time and an end time of the background processing, the background processing not being explicitly shown to a user by an apparatus itself from among a plurality of types processing; and
presentationing the particulars, the start time, and the end time of the background processing or transmitting them to an external device upon request.
